(19) United States
(12) Patent Application Publication
(10) Pub. No.: US 2022/0317653 A1
(43) Pub. Date: Oct. 6, 2022

(54) LASER PROJECTION FOR CNC WORKPIECE POSITIONING

(71) Applicant: Standex International Corporation, Salem, NH (US)

(72) Inventors: Massimiliano MORUZZI, Rockford, IL (US); Francesco IORIO, Toronto (CA)

(21) Appl. No.: 17/714,092

(22) Filed: Apr. 5, 2022

Related U.S. Application Data
(60) Provisional application No. 63/171,226, filed on Apr. 6, 2021.

(51) Int. Cl. G05B 19/402; G05B 19/4099; G05B 19/18

(52) U.S. Cl. CPC G05B 19/402; G05B 19/4099; G05B 19/182

(57) ABSTRACT

A computer-implemented method for positioning a workpiece within a processing system includes: extracting at least one feature of a workpiece from a three-dimensional model of the workpiece; determining a location of the at least one feature relative to a work surface of the processing system based on geometric information included in the three-dimensional model; and projecting a laser trace onto the location via a laser projector.

### CROSS-REFERENCE TO RELATED APPLICATIONS

This application claims priority benefit of the United States Provisional Patent Application titled, “LASER PROJECTION FOR MOLD POSITIONING,” filed on Apr. 6, 2021 and having Ser. No. 63/171,226. The subject matter of this related application is hereby incorporated herein by reference.

### BACKGROUND

### Field of the Various Embodiments

The various embodiments relate generally to laser engraving and computer numerical control (CNC) processing and, more specifically, to laser projection for CNC workpiece positioning.

### Description of the Related Art

CNC processing systems, such as CNC machining systems, three-dimensional printers, and laser-engraving machines, allow precise and repeatable processing of workpieces. Typically, manufacturing techniques using CNC processing systems can be highly automated, which enables high volume production of uniform products, even when those products have complex, three-dimensional surfaces.

Typically, an important requisite for the proper operation of a CNC processing system is the precise alignment and accurate positioning of a workpiece relative to the CNC processing system. For example, for a laser-engraving machine to obtain certain surface textures or pattern geometries, the workpiece or mold should be positioned on the work surface of the laser-engraving machine with sub-millimeter accuracy. Otherwise, when the actual workpiece location deviates too much from the assumed workpiece location, the programming for the laser-engraving machine used to perform a specified process on the workpiece can be rendered invalid.

More particularly, the programming for a laser-engraving machine is usually based on inverse kinematics simulations that are performed to ensure that no reachability issues or collisions with the workpiece occur during processing of the workpiece. These types of inverse kinematic simulations typically assume a specific workpiece location relative to the axes and work surface of the laser-engraving system. Accordingly, any significant deviation from the assumed workpiece location can result in collisions between the workpiece and the laser-engraving system and/or an inability for the laser-engraving system to reach certain portions of the workpiece. Further, deviation from the assumed workpiece location can adversely impact the laser-engraving process. This is because the simulations and other process tuning computations for achieving a particular texture or surface geometry assume specific laser paths relative to the workpiece surface and a predetermined focal length for each part of the laser-engraving process. Consequently, an inaccurately positioned workpiece can result in out-of-focus lasers and/or an unintentionally altered laser-engraving process that produces a different surface geometry or texture than was intended.

In current approaches, workpieces typically are positioned on the work surface of most CNC processing systems manually. For example, for very bulky or heavy workpieces, an operator manually guides the workpiece via a crane onto a work surface, confirms the position of the workpiece via a precision probing process, then initiates the CNC processing of the workpiece. One drawback to this approach is that achieving sub-millimeter positioning accuracy is very difficult when manually positioning bulky or heavy workpieces in this way. For example, to achieve any type of sufficient accuracy, an operator has to position and lower the workpiece onto a location of the work surface using a crane, perform a complete probing process of the workpiece to determine how much translational offset and rotational skew the current location of the workpiece has relative to the intended location, lift the workpiece with the crane, attempt to reposition the workpiece with the appropriate translation and rotation so that the workpiece is positioned at the intended location, and then repeat the probing process. Further, for many CNC processes, workpieces can weigh several tons and/or be very large. As a result, loading such workpieces onto a CNC processing system can require extensive trial and error, in which multiple cycles of workpiece positioning and probing have to performed before the workpiece is positioned with sufficient accuracy. With larger and/or heavier workpieces, hours can be required to achieve a desired positioning accuracy, which greatly reduces throughput of the CNC processing system.

As the foregoing illustrates, what is needed in the art are more effective ways to accurately position workpieces on CNC processing systems.

### SUMMARY

A computer-implemented method for positioning a workpiece within a processing system includes: extracting at least one feature of a workpiece from a three-dimensional model of the workpiece; determining a location of the at least one feature relative to a work surface of the processing system based on geometric information included in the three-dimensional model; and projecting a laser trace onto the location via a laser projector

At least one technical advantage of the disclosed techniques relative to the prior art is that the disclosed techniques enable a workpiece to be positioned accurately within a CNC processing system in a single iteration of workpiece placement and position confirmation. In this regard, one or more laser traces provide immediate and precise feedback and guidance with respect to workpiece position, which obviates the need for repeated cycles of placing and measuring the position of the workpiece. A further advantage is that the laser traces provide visual confirmation that key features of the intended workpiece match corresponding features of the workpiece being positioned on the CNC processing system, thereby establishing a level of quality assurance that is not available with prior art techniques. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments.

FIG. 2 is a more detailed illustration of a workpiece that can be positioned with the workpiece setup system of FIG. 1, according to various embodiments.

FIG. 3 sets forth a flowchart of method steps for positioning a workpiece within a CNC processing system, according to various embodiments.

FIG. 4 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### CNC Processing System and Workpiece Setup

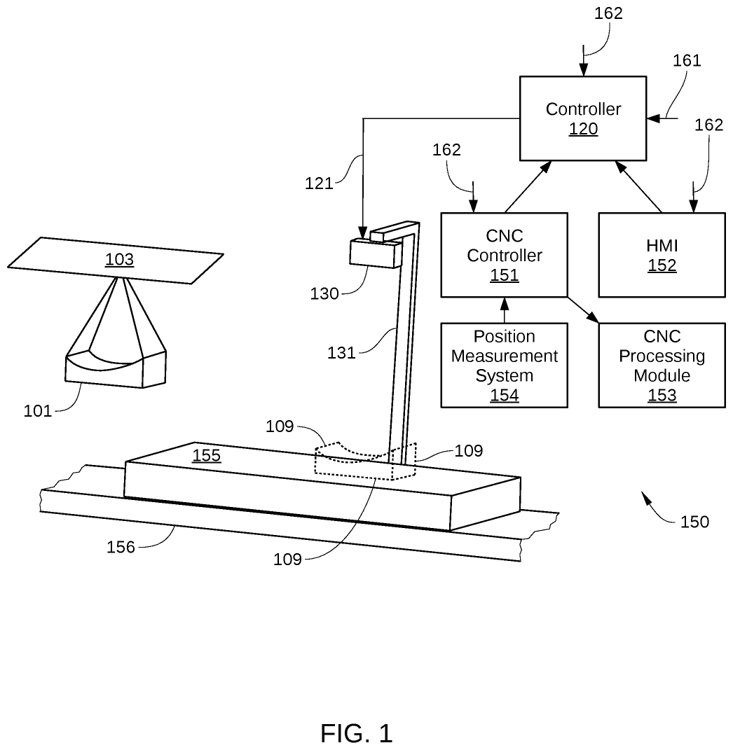

FIG. 1 illustrates a system configured to implement one or more aspects of the various embodiments. The system shown includes a workpiece setup system 100 and an associated computer numerical control (CNC) processing system 150. CNC processing system 150 can be any computer-controlled workpiece processing system, such as a machining system (mill, lathe, drill, and/or the like), an array of multiple such machining systems, a three-dimensional (3D) printers, a laser-engraving machine, and the like. As such, CNC processing system 150 is configured to perform one or more precise and repeatable processes on a workpiece 101, including material removal, surface texturization and/or functionalization, and coating application, among others. Generally, the quality of the output of such processes is facilitated by accurate positioning of workpiece 101 on a work surface 155 of CNC processing system 150, for example, via a crane 103. According to various embodiments, workpiece setup system 100 is configured to enable such positioning of workpiece 101 by an operator without the need for multiple cycles of workpiece placement and position measurement.

In the embodiment illustrated in FIG. 1, CNC processing system 150 includes a CNC controller 151, a human-machine interface (HMI) 152, a CNC processing module 153, and a position measurement system 154. Human-machine interface 152 receives user inputs 162, such as information indicating the next workpiece 101 to be processed by CNC processing system 150, a particular process to be performed on workpiece 101, and the like.

CNC processing module 153 is configured to perform one or more processes on workpiece 101, such as material removal (e.g., milling, drilling, and/or lathe operations), surface texturization and/or surface functionalization (e.g., via laser ablation), and the like. For example, in some embodiments, CNC processing module 153 includes one or more motorized maneuverable tools that are controlled based on machine control instructions for a specific process to be performed on workpiece 101. In such embodiments, each maneuverable tool may include one or more robotic joints and associated actuators (not shown), such as wrist joints, elbow joints, base joints, and the like. Alternatively or additionally, in some embodiments, CNC processing module 153 includes a laser-engraving head and a positioning apparatus for locating and orienting the laser-engraving head in two or three dimensions with respect to workpiece 101. In such embodiments, the laser-engraving engraving head typically includes a laser source for generating suitable laser pulses and a mirror positioning system and laser optics to direct the pulses to specific locations within an engraving region. The positioning apparatus can be any suitable multi-axis position device or assembly that locates and orients engraving head assembly.

Position measurement system 154 is configured to facilitate and/or perform probing of and/or other position measurements on workpiece 101 when workpiece 101 is disposed on work surface 155. For example, in some embodiments, position measurement system 154 includes one or more integrated computer-controlled probe tools for precisely measuring the location of specific features of workpiece 101. In some embodiments, position measurement system 154 is configured to determine the current position of workpiece 101 relative to CNC processing system 150 based on such measurements. Alternatively or additionally, in some embodiments, position measurement system 154 includes one or more external measurement devices or apparatuses for measuring and determining the location of specific features of workpiece 101.

CNC controller 151 controls the operations of CNC processing system 150. In some embodiments, CNC controller 151 receives user inputs 162 and/or a 3D model 161 fora particular workpiece 101 via HMI 152. In some embodiments, CNC controller 151 is further configured to generate and execute a sequential program of machine control instructions (e.g., G-code and/or M-code) based on 3D model 161. Alternatively or additionally, in some embodiments, 3D model 161 includes a suitable sequential program of machine control instructions that are generated via computer-aided design (CAD) or computer-aided manufacturing (CAM) software by a computing device external to CNC processing system 150.

CNC processing system 150 further includes work surface 155 for supporting workpiece 101 during CNC processing. In the embodiment illustrated in FIG. 1, work surface 155 is disposed on a motorized movable platform 156 included in CNC processing system 150. In such embodiments, motorized movable platform 156 can be controlled by CNC controller 151 via sequential program of machine control instructions based on 3D model 161.

Workpiece setup system 100 facilitates the accurate positioning of workpiece 101 on work surface 155 via a laser projector 130. Specifically, laser projector 130 projects one or more laser traces 109 onto one or more target locations, where each target location corresponds to a different feature of workpiece 101. Thus, as an operator or other user of CNC processing system 150 maneuvers workpiece 101 onto work surface 155, the one or more projected laser traces 109 illuminate surfaces, edges, or other salient features of workpiece 101. In this way, the one or more projected laser traces 109 indicate the current position of certain features of workpiece 101 relative to the final target position of those features.

For clarity of description, in FIG. 1, each laser trace 109 is shown at a projected location in three dimensional space that corresponds to the target position of the feature associated with that laser trace 109. In practice, laser projector 130 projects each laser trace 109 through the target position of the feature associated with that laser trace 109, and therefore each laser trace 109 is projected onto any surface that is aligned with laser projector 130 and laser trace 109. For example, when workpiece 101 is not disposed on work surface 155, laser traces 109 are projected onto work surface 155. However, when workpiece 101 is disposed on work surface 155, laser traces are projected onto surfaces and features of workpiece 101, thereby providing visual indicators to an operator of the current position of work piece 101 relative to the target position of work piece 101.

In the embodiment illustrated in FIG. 1, workpiece setup system 100 includes a controller 120 and a laser projector 130. Controller 120 receives 3D model 161 of workpiece 101, extracts one or more features of workpiece 101 from 3D model 161, determines a location for each extracted feature, and determines a set of laser scanning instructions for workpiece 101 based on the determined locations. Laser projector 130 then projects a laser trace 109 onto each of the locations based on the laser scanning instructions for workpiece 101.

In some embodiments, controller 120 extracts the one or more features from 3D model 161 based on one or more user inputs 162. In such embodiments, a user input 162 can reference or include specific features of workpiece 101 to be indicated with a laser trace 109. For example, in some embodiments, a user can provide such input via HMI 152 of CNC processing system 150 and/or via an HMI (not shown) associated with workpiece setup system 100.

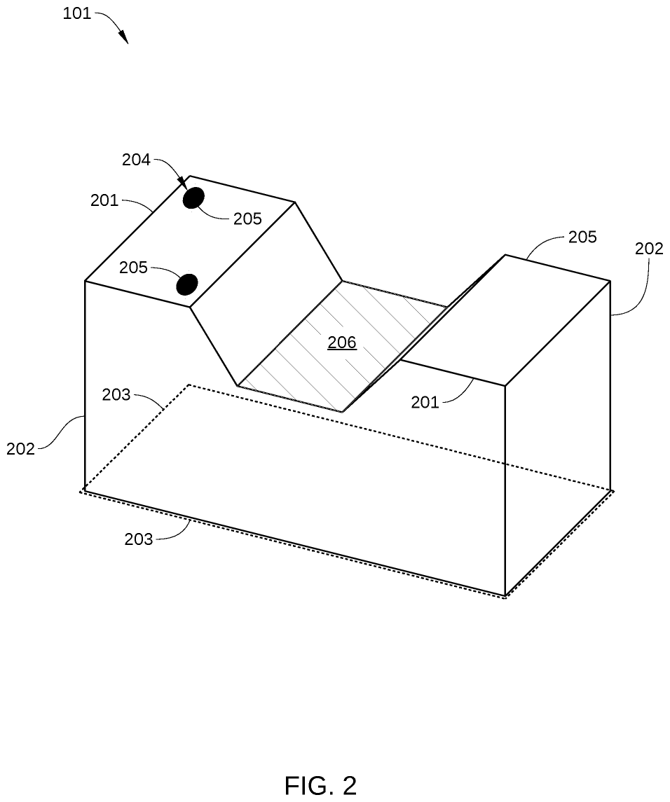

In some embodiments, controller 120 extracts the one or more features from 3D model 161 in an automated process. In such embodiments, controller 120 extracts the one or more features based on geometric information included in 3D model 161. For example, in such embodiments, the geometric information indicates one or more specific features of workpiece 101. An embodiment of workpiece 101 and various features is described below in conjunction with FIG. 2.

FIG. 2 is a more detailed illustration of workpiece 101 that can be positioned with workpiece setup system 100, according to various embodiments. In the embodiment illustrated in FIG. 2, workpiece 101 can include one or more edges, such as top edges 201 and/or outer edges 202, a footprint 203 (dashed line), one or more datum features 204, one or more machined features 205, and/or one or more surfaces 206 (cross-hatched). As shown, in some embodiments, footprint 203 corresponds to a perimeter of a base plane of workpiece 101, such as a surface of workpiece 101 that contacts work surface 155 when workpiece 101 is correctly positioned on work surface 155 for processing. In some embodiments, a datum features 204 can be any physical feature of workpiece 101 that corresponds to or is associated with a datum (e.g., a plane, line, or point) referenced in 3D model 161. In some embodiments, machined features 205 include a drilled hole, a flat, a corner, a radius, and/or the like.

Returning to FIG. 1, in some embodiments, controller 120 determines a set of laser scanning instructions 121 for workpiece 101 based on geometric information for each location that is associated with an extracted feature. In some embodiments, the geometric information is included in 3D model 161. In such embodiments, the geometric information may include positional information for a particular extracted feature and/or dimensional information for the particular extracted feature. Further, in some embodiments, controller 120 determines one or more projection parameter values for projecting the visual indicators for the extracted features. In such embodiments, controller 120 determines values for one or more projection parameters such as laser color, laser brightness, laser trace thickness, and/or the like.

In some embodiments, in addition to causing laser projector 130 to project a laser trace 109 for each feature extracted from 3D model 161, controller 120 is configured to cause laser projector 130 to project textual information onto work surface 155. In such embodiments, the textual information can include textual content for guiding an operator or other user of CNC processing system 150. For example, the textual content can indicate a specific feature of workpiece 101 and/or an alignment procedure associated with that specific feature. In another example, the textual content can indicate a specific feature of workpiece 101 that differentiated workpiece 101 from another workpiece that is visually similar to workpiece 101. Alternatively or additionally, in some embodiments, controller 120 is configured to cause laser projector 130 to project textual information onto one or more surfaces of workpiece 101 while workpiece 101 is guided to work surface 155.

Laser projector 130 is coupled to a support 131 and is oriented to direct one or more output lasers 132 toward work surface 155. In some embodiments, support 131 precisely positions laser projector relative to work surface 155 and/or other components of CNC processing system 150. Laser projector 130 can be any technically feasible laser projector that is configured to generate a laser trace 109 onto a three-dimensional shape or location. For example, in some embodiments, laser projector 130 includes one or more galvanometers, which are computer-controlled electromagnetic devices that move mirrors at high speeds to reflect a laser beam and draw images on a surface and/or project images into three dimensional space.

### Laser Projection for CNC Workpiece Positioning

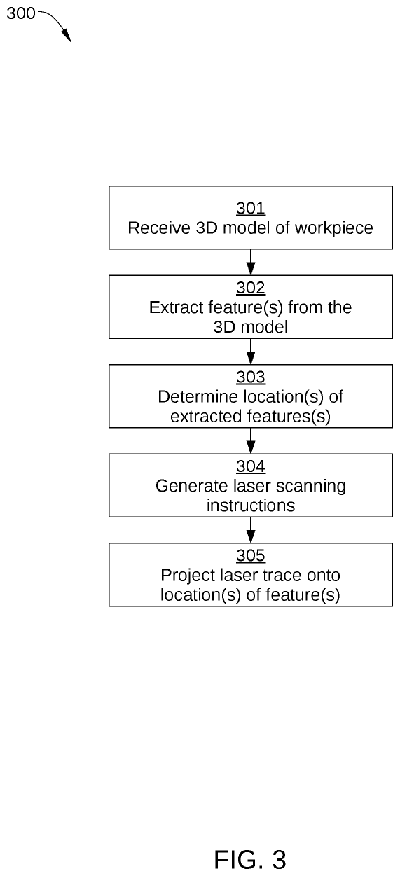

FIG. 3 sets forth a flowchart of method steps for positioning a workpiece within CNC processing system 150, according to various embodiments. Although the method steps are described in conjunction with the systems of FIG. 1, persons skilled in the art will understand that any system configured to perform the method steps, in any order, is within the scope of the embodiments.

As shown, a computer-implemented method 300 begins at step 301, where workpiece setup system 100 receives 3D model 161, for example via controller 120. In some embodiments, controller 120 receives 3D model 161 in an automated process. For example, in such embodiments, an automated identification of workpiece 101 may cause controller 120 to receive 3D model 161, such as via bar code identification of workpiece 101. Alternatively or additionally, in such embodiments, controller 120 receives 3D model 161 from CNC processing system 150 when processing of workpiece 101 is requested by a user or is initiated by the automated identification of workpiece 101. Alternatively or additionally, in some embodiments, controller 120 receives 3D model 161 based on one or more user inputs 162. In such embodiments, a user input 162 can indicate a specific workpiece 101 to be processed by CNC processing system 150.

In some embodiments, in step 301, workpiece setup system 100 further receives processing information associated with workpiece 101. Such processing information can include positioning information for workpiece 101 relative to work surface 155, specific features of workpiece 101 that are to be indicated via a laser trace 109, and the like. In some embodiments, controller 120 receives such processing information in an automated process. For example, in such embodiments, the processing information may be received in conjunction with 3D model 161. Alternatively, such processing information may be received via one or more user inputs 162.

In step 302, workpiece setup system 100 extracts one or more features of workpiece 101 from 3D model 161, for example via controller 120. In some embodiments, indications of such features are included in 3D model 161, and controller extracts one or more features based on such indications. Alternatively or additionally, in some embodiments, controller 120 performs any technically feasible algorithm to extract one or more features of workpiece 101.

In step 303, workpiece setup system 100 determines a location for each of the one or more features of workpiece 101 extracted from 3D model 161 in step 302. In general, the locations determined in step 303 are located in three-dimensional space, and are not limited to locations on work surface 155. Because laser projector 130 is positioned at a known location relative to work surface 155, in some embodiments, the locations are determined relative to work surface 155 and/or other components of CNC processing system 150.

In some embodiments, controller 120 determines the locations for each of the one or more extracted features based on geometric information included in the model. As noted previously, in some embodiments, such geometric information can include position information for each extracted feature. Alternatively or additionally, in such embodiments, the geometric information indicates one or more top edges 201, outer edges 202, a footprint 203, one or more datum features 204, one or more machined features 205, and/or one or more surfaces 206. Alternatively or additionally, in some embodiments, controller 120 determines such locations based on process information associated with workpiece 101, such as positioning information for workpiece 101 relative to work surface 155 for a particular CNC process.

In step 304, workpiece setup system 100 determines a set of laser scanning instructions for generating laser traces 109, for example via controller 120. In some embodiments, controller 120 determines the set of laser scanning instructions for generating each laser trace 109 based on geometric information associated with the location for that laser trace 109, such as geometric information included in 3D model 161.

In some embodiments, the set of laser scanning instructions includes values for the various laser-scanning parameters for laser projector 130. Examples of such laser-scanning parameters include parameters that control the motion of a laser-directing system included in laser projector 130, such as the mirrors of a galvanometer-based optical scanner. Further examples of such laser-scanning parameters include parameters that precisely pulse the projection laser or lasers of laser projector 130 at appropriate times (in coordination with the motion of the laser-directing system) and with appropriate pulse energies.

In step 305, workpiece setup system 100 projects one or more laser traces 109 onto (or through) the locations of the one or more features extracted from 3D model 161 in step 302, for example via laser projector 130. As noted previously, laser projector 130 projects each laser trace 109 through the target position of the feature associated with that laser trace 109. Thus, laser traces 109 are projected onto work surface 155 when workpiece 101 is not disposed on work surface 155 and onto the corresponding features of workpiece 101 when workpiece 101 is accurately positioned on work surface 155.

In some embodiments, laser projector 130 projects multiple laser traces 109 simultaneously. Thus, in such embodiments, some or all features of workpiece 101 extracted in step 302 can be indicated simultaneously by laser traces 109. Alternatively or additionally, in some embodiments, laser projector 130 projects laser traces 109 for certain extracted features and does not project laser traces 109 for certain other extracted features. In such embodiments, an operator can selectively cause laser projector 130 to project some or all laser traces 109 for the extracted features, for example via a user input 162.

Implementation of method 300 enables an operator to manually guide workpiece 101 onto a target position on work surface 155 with high accuracy. As a result, multiple cycles of workpiece positioning and probing are not necessary during setup of workpiece 101.

### Exemplary Computing Device

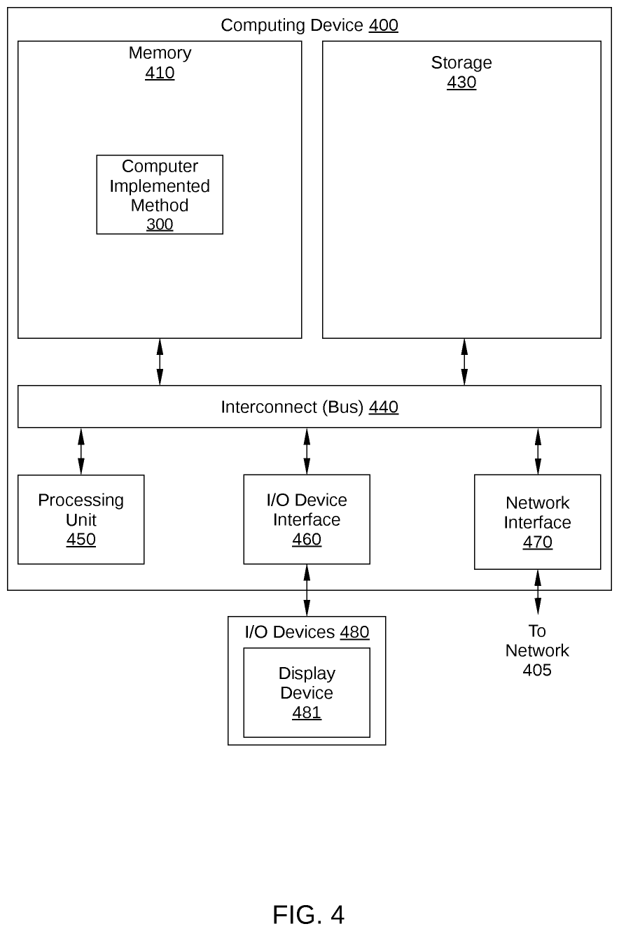

FIG. 4 is a block diagram of a computing device 400 configured to implement one or more aspects of the various embodiments. Thus, computing device 400 can be a computing device associated with a workpiece setup system 100, CNC processing system 150, and/or controller 120. Computing device 400 may be a desktop computer, a laptop computer, a tablet computer, or any other type of computing device configured to receive input, process data, generate control signals, and display images. Computing device 400 is configured to perform operations associated with computer-implemented method 300 and/or other suitable software applications, which can reside in a memory 410. It is noted that the computing device described herein is illustrative and that any other technically feasible configurations fall within the scope of the present disclosure.

As shown, computing device 400 includes, without limitation, an interconnect (bus) 440 that connects a processing unit 450, an input/output (I/O) device interface 460 coupled to input/output (I/O) devices 480, memory 410, a storage 430, and a network interface 470. Processing unit 450 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 450 may be any technically feasible hardware unit capable of processing data and/or executing software applications, including processes associated with computer-implemented method 300. Further, in the context of this disclosure, the computing elements shown in computing device 400 may correspond to a physical computing system (e.g., a system in a data center) or may be a virtual computing instance executing within a computing cloud.

I/O devices 480 may include devices capable of providing input, such as a keyboard, a mouse, a touch-sensitive screen, and so forth, as well as devices capable of providing output, such as a display device 481. Additionally, I/O devices 480 may include devices capable of both receiving input and providing output, such as a touchscreen, a universal serial bus (USB) port, and so forth. I/O devices 480 may be configured to receive various types of input from an end-user of computing device 400, and to also provide various types of output to the end-user of computing device 400, such as one or more graphical user interfaces (GUI), displayed digital images, and/or digital videos. In some embodiments, one or more of I/O devices 480 are configured to couple computing device 400 to a network 405.

Memory 410 may include a random access memory (RAM) module, a flash memory unit, or any other type of memory unit or combination thereof. Processing unit 450, I/O device interface 460, and network interface 470 are configured to read data from and write data to memory 410. Memory 410 includes various software programs that can be executed by processor 450 and application data associated with said software programs, including computer-implemented method 300.

In sum, the various embodiments described herein provide techniques for guiding an operator in the positioning of a workpiece for CNC processing. A laser projector projects one or more laser traces onto one or more target locations, where each target locations corresponds to a different feature of the workpiece. Thus, as the operator maneuvers workpiece onto a work surface of a CNC processing system, the one or more projected laser traces illuminate surfaces, edges, or other salient features of the workpiece. In this way, the one or more projected laser traces indicate the current position of certain features of the workpiece relative to the final target position of those features.

At least one technical advantage of the disclosed techniques relative to the prior art is that the disclosed techniques enable a workpiece to be positioned accurately within a CNC processing system in a single iteration of workpiece placement and position confirmation. In this regard, one or more laser traces provide immediate and precise feedback and guidance with respect to workpiece position, which obviates the need for repeated cycles of placing and measuring the position of the workpiece. A further advantage is that the laser traces provide visual confirmation that key features of the intended workpiece match corresponding features of the workpiece being positioned on the CNC processing system, thereby establishing a level of quality assurance that is not available with prior art techniques. These technical advantages provide one or more technological advancements over prior art approaches.

1. In some embodiments, a computer-implemented method for positioning a workpiece within a processing system includes: extracting at least one feature of a workpiece from a three-dimensional model of the workpiece; determining a location of the at least one feature relative to a work surface of the processing system based on geometric information included in the three-dimensional model; and projecting a laser trace onto the location via a laser projector.

2. The computer-implemented method of clause 1, wherein the geometric information for the workpiece includes at least one of a datum feature of the workpiece or a machined feature of the workpiece.

3. The computer-implemented method of clauses 1 or 2, wherein extracting the at least one feature of the workpiece from the three-dimensional model comprises extracting the at least one feature based on the geometric information included in the three-dimensional model.

4. The computer-implemented method of any of clauses 1-3, wherein the geometric information indicates one or more of a top surface of the workpiece, an outer edge of the workpiece, a footprint of the workpiece, a datum feature of the workpiece, or a machined feature of the workpiece.

5. The computer-implemented method of any of clauses 1-4, wherein the at least one feature includes a top surface of the workpiece, an outer edge of the workpiece, a footprint of the workpiece, a datum feature of the workpiece, or a machined feature of the workpiece.

6. The computer-implemented method of any of clauses 1-5, further comprising determining a projection parameter value to use when projecting the laser trace.

7. The computer-implemented method of any of clauses 1-6, further comprising determining a set of laser scanning instructions based on positioning information associated with the location.

8. The computer-implemented method of any of clauses 1-7, wherein the location resides proximate to, but not on, the work surface of the CNC processing system.

9. In some embodiments, a non-transitory computer readable medium stores instructions that, when executed by a processor, cause the processor to perform the steps of: extracting at least one feature of a workpiece from a three-dimensional model of the workpiece; determining a location of the at least one feature relative to a work surface of the processing system based on geometric information included in the three-dimensional model; and projecting a laser trace onto the location via a laser projector.

10. The non-transitory computer readable medium of clause 9, wherein the steps further comprise projecting textual information onto the work surface of the CNC processing system via the laser projector.

11. The non-transitory computer readable medium of clauses 9 or 10, wherein the textual information is projected while the laser trace is being projected.

12. The non-transitory computer readable medium of any of clauses 9-11, wherein determining the location of the at least one feature relative to the work surface is further based on process information associated with the workpiece.

13. The non-transitory computer readable medium of any of clauses 9-12, wherein the geometric information included in the three-dimensional model describes a three-dimensional shape of the workpiece.

14. The non-transitory computer readable medium 9-13, wherein extracting the at least one feature of the workpiece from the three-dimensional model comprises extracting the at least one feature based on the geometric information included in the three-dimensional model.

15. The non-transitory computer readable medium of any of clauses 9-14, wherein the geometric information indicates one or more of a top surface of the workpiece, an outer edge of the workpiece, a footprint of the workpiece, a datum feature of the workpiece, or a machined feature of the workpiece.

16. In some embodiments, an apparatus for positioning a workpiece within a processing system includes: a laser projector disposed proximate a work surface of a processing system; and a controller configured to perform the steps of: extracting at least one feature of a workpiece from a three-dimensional model of the workpiece; determining a location of the at least one feature relative to the work surface of the processing system based on geometric information included in the three-dimensional model; and projecting a laser trace onto the location via a laser projector.

17. The apparatus of clause 16, wherein the laser projector is configured to generate the laser trace on a location having a three-dimensional shape.

18. The apparatus of clauses 16 or 17, wherein the laser projector is disposed at a known location relative to the work surface.

19. The apparatus of any of clauses 16-18, wherein the laser projector is disposed at a known location relative to one or more components of the processing system.

20. The apparatus of any of clauses 16-19, wherein the at least one feature includes a top surface of the workpiece, an outer edge of the workpiece, a footprint of the workpiece, a datum feature of the workpiece, or a machined feature of the workpiece.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for positioning a workpiece within a processing system, the method comprising:
extracting at least one feature of a workpiece from a three-dimensional model of the workpiece;
determining a location of the at least one feature relative to a work surface of the processing system based on geometric information included in the three-dimensional model; and
projecting a laser trace onto the location via a laser projector.

2. The computer-implemented method of claim 1, wherein the geometric information for the workpiece includes at least one of a datum feature of the workpiece or a machined feature of the workpiece.

3. The computer-implemented method of claim 1, wherein extracting the at least one feature of the workpiece from the three-dimensional model comprises extracting the at least one feature based on the geometric information included in the three-dimensional model.

4. The computer-implemented method of claim 3, wherein the geometric information indicates one or more of a top surface of the workpiece, an outer edge of the workpiece, a footprint of the workpiece, a datum feature of the workpiece, or a machined feature of the workpiece.

5. The computer-implemented method of claim 1, wherein the at least one feature includes a top surface of the workpiece, an outer edge of the workpiece, a footprint of the workpiece, a datum feature of the workpiece, or a machined feature of the workpiece.

6. The computer-implemented method of claim 1, further comprising determining a projection parameter value to use when projecting the laser trace.

7. The computer-implemented method of claim 1, further comprising determining a set of laser scanning instructions based on positioning information associated with the location.

8. The computer-implemented method of claim 1, wherein the location resides proximate to, but not on, the work surface of the CNC processing system.

9. A non-transitory computer readable medium storing instructions that, when executed by a processor, cause the processor to perform the steps of:
extracting at least one feature of a workpiece from a three-dimensional model of the workpiece;
determining a location of the at least one feature relative to a work surface of the processing system based on geometric information included in the three-dimensional model; and
projecting a laser trace onto the location via a laser projector.

10. The non-transitory computer readable medium of claim 9, wherein the steps further comprise projecting textual information onto the work surface of the CNC processing system via the laser projector.

11. The non-transitory computer readable medium of claim 10, wherein the textual information is projected while the laser trace is being projected.

12. The non-transitory computer readable medium of claim 9, wherein determining the location of the at least one feature relative to the work surface is further based on process information associated with the workpiece.

13. The non-transitory computer readable medium of claim 9, wherein the geometric information included in the three-dimensional model describes a three-dimensional shape of the workpiece.

14. The non-transitory computer readable medium 9, wherein extracting the at least one feature of the workpiece from the three-dimensional model comprises extracting the at least one feature based on the geometric information included in the three-dimensional model.

15. The non-transitory computer readable medium of claim 14, wherein the geometric information indicates one or more of a top surface of the workpiece, an outer edge of the workpiece, a footprint of the workpiece, a datum feature of the workpiece, or a machined feature of the workpiece.

16. An apparatus for positioning a workpiece within a processing system, the apparatus comprising:
a laser projector disposed proximate a work surface of a processing system; and
a controller configured to perform the steps of:
extracting at least one feature of a workpiece from a three-dimensional model of the workpiece;
determining a location of the at least one feature relative to the work surface of the processing system based on geometric information included in the three-dimensional model; and
projecting a laser trace onto the location via a laser projector.

17. The apparatus of claim 16, wherein the laser projector is configured to generate the laser trace on a location having a three-dimensional shape.

18. The apparatus of claim 16, wherein the laser projector is disposed at a known location relative to the work surface.

19. The apparatus of claim 16, wherein the laser projector is disposed at a known location relative to one or more components of the processing system.

20. The apparatus of claim 16, wherein the at least one feature includes a top surface of the workpiece, an outer edge of the workpiece, a footprint of the workpiece, a datum feature of the workpiece, or a machined feature of the workpiece.
